(19) United States
(12) Patent Application Publication
(10) Pub. No.: US 2020/0374977 A1
(43) Pub. Date: Nov. 26, 2020

(54) INFORMATION PROCESSING SYSTEM AND RELAY DEVICE

(71) Applicant: FUJITSU CLIENT COMPUTING LIMITED, Kanagawa (JP)

(72) Inventors: Masatoshi Kimura, Kawasaki (JP); Yuji Nakayama, Kawasaki (JP); Tomohiro Ishida, Kawasaki (JP)

(73) Assignee: FUJITSU CLIENT COMPUTING LIMITED, Kanagawa (JP)

(21) Appl. No.: 15/930,821

(22) Filed: May 13, 2020

(30) Foreign Application Priority Data
May 20, 2019 (JP) 2019-094753

(51) Int. Cl. H04W 88/04; H04W 84/04; H04W 40/22; H04L 29/12

(52) U.S. Cl. CPC H04W 88/04; H04L 61/6022; H04W 40/22; H04W 84/047

(57) ABSTRACT

An information processing system includes: a first relay device provided with a plurality of end points and a root complex for relay; and a second relay device provided with a plurality of end points and an end point for relay. The plurality of end points of the first relay device individually connects to any of a plurality of first information processing devices over an expansion bus. The root complex for relay: relays communication between the first information processing devices via the corresponding end points of the first relay device; connects to the second relay device over an expansion bus; and functions as a root complex. The plurality of end points of the second relay device individually connects to any of a plurality of second information processing devices over an expansion bus.

### CROSS-REFERENCE TO RELATED APPLICATIONS

This application is based upon and claims the benefit of priority from Japanese Patent Application No. 2019-094753, filed May 20, 2019, the entire contents of which are incorporated herein by reference.

### FIELD

Embodiments described herein relate to an information processing system and a relay device.

### BACKGROUND

In an information processing system, in which a plurality of information processing devices are connected via a relay device including a plurality of connection I/F (for example, expansion bus slots), parallel distributed control to distribute pieces of processing among the information processing devices may be performed.

In such an information processing system, in a case of trying to perform communication between the information processing devices connected over the connection I/F (expansion bus slot), it is required to assign an address to each of the information processing devices.

However, in the information processing system of the related art mentioned above, when an address is assigned to each of the information processing devices connected to the respective relay devices, an address conflict may be arisen.

### SUMMARY

An information processing system according to a first aspect of the present disclosure includes a first relay device and a second relay device. The first relay device is provided with a plurality of end points and a root complex for relay. The second relay device is provided with a plurality of end points and an end point for relay. The plurality of end points of the first relay device are configured to be individually connectable to any of a plurality of first information processing devices over an expansion bus. The root complex for relay is configured to: relay communication between the first information processing devices via the corresponding end points of the first relay device; be connectable to the second relay device over an expansion bus; and function as a root complex. The plurality of end points of the second relay device are configured to be individually connectable to any of a plurality of second information processing devices over an expansion bus. The end point for relay is configured to: relay communication between the second information processing devices via the corresponding end points of the second relay device; be connectable to the first relay device over an expansion bus; and function as an end point. The second relay device is configured to relay communication between the first information processing devices and the second information processing devices via the end point for relay. The first relay device or the second relay device further comprises a memory and one or more hardware processors. The memory is configured to store address specifying information used for assigning addresses to the first information processing devices or the second information processing devices connected to the respective positions of the corresponding end points, the addresses to be assigned being based on a relation between the first relay device and the second relay device and based on positions of the end points of the first relay device or the second relay device. The one or more hardware processors are configured to: specify the relation between the first relay device and the second relay device; and assign the addresses to the first information processing devices or the second information processing devices connected to the end points of the first relay device or the second relay device based on the specified relation, the positions of the connected end points, and the address specifying information.

A relay device according to a second aspect of the present disclosure includes a plurality of end points, a root complex for relay or an end point for relay, and a memory. The plurality of end points is configured to be individually connectable to any of a plurality of information processing devices over an expansion bus. The root complex for relay or an end point for relay is configured to be connectable to another relay device over an expansion bus, and function as a root complex or an end point. The memory is configured to store address specifying information used for assigning addresses to the information processing devices connected to the respective positions of the end points, the addresses to be assigned being based on a relation with another relay device and positions of the end points.

### BRIEF DESCRIPTION OF THE DRAWINGS

FIG. 1 is a diagram illustrating an example of a whole configuration of an information processing system according to an embodiment;

FIG. 2 is a block diagram exemplifying software configurations of a main unit and platforms according to the embodiment;

FIG. 3 is a diagram exemplifying a main ID and a sub ID assigned to each of the main unit and the platforms according to the embodiment;

FIG. 4 is a diagram exemplifying a table structure of address specifying information stored in a memory according to the embodiment;

FIG. 5 is a flowchart illustrating processing for specifying a virtual MAC address of the platform according to the embodiment;

FIG. 6 is a flowchart illustrating processing for transmitting information by the platform according to the embodiment; and

FIG. 7 is an explanatory diagram exemplifying a configuration of a common memory in each platform according to a modification.

### DETAILED DESCRIPTION

According to the information processing system disclosed herein, it is capable of implementing appropriate communication processing between the information processing devices connected via the relay devices.

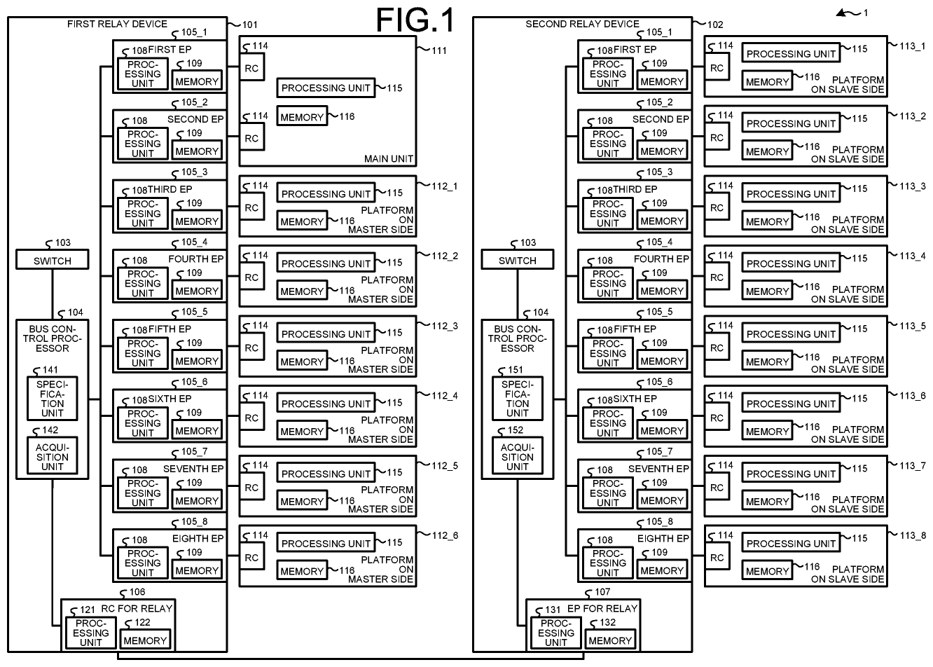

FIG. 1 is a diagram illustrating an example of a whole configuration of an information processing system according to an embodiment. As illustrated in FIG. 1, an information processing system 1 according to the present embodiment includes a first relay device 101, a second relay device 102, a main unit 111, a plurality of platforms 112-1 to 112-6 on a master side, and a plurality of platforms 113-1 to 113-8 on a slave side.

The first relay device 101 and the second relay device 102 are connected to each other over an expansion bus (in the present embodiment, a PCI Express bus (hereinafter, also referred to as a PCIe bus)). In the present embodiment, the first relay device 101 functions as a master, and the second relay device 102 functions as a slave.

The main unit 111 and the platforms 112_1 to 112_6 on the master side are connected to the first relay device 101 over the expansion bus (for example, the PCIe bus).

In the following description, when the platforms 112_1 to 112_6 on the master side are not required to be distinguished from each other, the platforms 112_1 to 112_6 on the master side may be collectively referred to as a platform 112 on the master side. The following describes an example in which the information processing system 1 according to the present embodiment includes six platforms on the master side. However, it is sufficient for the information processing system 1 to include two or more platforms (information processing devices).

The platforms 113_1 to 113_8 on the slave side are connected to the second relay device 102 over the expansion bus (for example, the PCIe bus).

In the following description, when the platforms 113_1 to 113_8 on the slave side are not required to be distinguished from each other, the platforms 113_1 to 113_8 on the slave side may be collectively referred to as a platform 113 on the slave side. The following describes an example in which the information processing system 1 according to the present embodiment includes eight platforms on the slave side. However, it is sufficient that the information processing system 1 includes two or more platforms (information processing devices).

When the platforms 112_1 to 112_6 on the master side and the platforms 113_1 to 113_8 on the slave side are not required to be distinguished from each other, the platforms 112_1 to 112_6 on the master side and the platforms 113_1 to 113_8 on the slave side may be collectively referred to as platforms 112 and 113.

The first relay device 101 is provided with a switch 103 and a bus control processor 104. The first relay device 101 is also provided with eight end points 105 (a first end point 105_1 to an eighth end point 105_8) as a plurality of connection units that are connectable to the main unit 111 and the platforms 112 on the master side. The first relay device 101 is also provided with a root complex (RC) for relay 106 as a relay connection unit that is connectable to another relay device, the RC enabling the first relay device 101 to connect to the second relay device 102.

When the first end point 105_1 to the eighth end point 105_8 are not required to be distinguished from each other, the first end point 105_1 to the eighth end point 105_8 may be collectively referred to as the end point 105.

The switch 103 is a hardware switch configured to switch the first relay device 101 between the master and the slave. In the present embodiment, while the switch 103 of the first relay device 101 is set to be the master, the switch 103 of the second relay device 102 is set to be the slave. Accordingly, the first relay device 101 functions as the master, and the second relay device 102 functions as the slave.

The bus control processor 104 of the first relay device 101 controls communication with each of the main unit 111 and the platforms 112 on the master side connected to the respective end points 105. The bus control processor 104 of the first relay device 101 controls communication with the platforms 113 on the slave side connected to the second relay device 102 via the relay root complex 106 of the expansion bus (in the present embodiment, the PCIe bus). The bus control processor 104 is not limited to a single processor, and may be configured by combining a plurality of processors.

The bus control processor 104 includes a specification unit 141 and an acquisition unit 142 as software configurations. For example, the bus control processor 104 implements the specification unit 141 and the acquisition unit 142 such that a central processor unit (CPU) (not illustrated) reads a computer program corresponding to those units from a read only memory (ROM) (not illustrated) and executes the computer program.

The specification unit 141 specifies a relation between the first relay device 101 and the second relay device 102, in other words, specifies that the first relay device 101 is the master or the slave, by referring to a setting of the switch 103. The specification unit 141 according to the present embodiment specifies that the first relay device 101 is the master. The present embodiment describes, as an example of specifying the relation between the relay devices, processing of specifying that the relay device is the master or the slave. However, the embodiment is not limited to the specification as to the master or the slave. In a case in which three or more relay devices are connected, a hierarchy thereof and the like may be specified. Then, the bus control processor 104 of the first relay device 101 performs control based on the relation between the relay devices.

The acquisition unit 142 accesses the root complex (RC) for relay 106 to acquire state information representing presence/absence of connection to each of the end points 105 of the second relay device 102. The acquisition unit 142 then transmits the acquired state information to each of the end points 105 of the first relay device 101. Thus, each of the end points 105 is able to recognize a connection state of the second relay device 102.

The first end point (EP) 105_1 to the eighth end point (EP) 105_8 each include a processing unit 108 and a memory 109, and also includes a connection I/F with the expansion bus (PCIe bus) for making connection with the main unit 111 or each of the platforms 112 and 113.

The memory 109 of the end point 105 is an example of a storage unit configured to store address specifying information used for assigning a corresponding MAC address to each of the main unit 111 and the platforms 112 and 113. Details thereof will be described later. The processing unit 108 of the end point 105 performs data transfer to/from a root complex 114 included in the main unit 111 or the platforms 112 and 113, each being connected via the connection I/F.

The processing unit 108 can identify the connection state of each of the end points 105 of the first relay device 101 (i.e., identify whether the main unit or the platform 112 on the master side is connected to each end point 105) over an internal bus of the first relay device 101.

The processing unit 108 can also identify whether the platform is connected to the end point 105 in the second relay device 102 by receiving the state information from the acquisition unit 142.

The processing unit 108 then performs processing for writing an identification result and the received state information into a memory 116 of the root complex 114. By this processing, a processing unit 115 of the root complex 114 can recognize the connection state of each of the end points 105 of the first relay device 101 and the second relay device 102.

The root complex (RC) for relay 106 includes a processing unit 121 and a memory 122, and also includes a connection I/F for making connection with an end point (EP) for relay 107.

The root complex for relay 106 is configured to relay communication between the platforms 112 on the master side and the platforms 113 on the slave side via the relay end point 107.

The memory 122 of the root complex for relay 106 stores the state information representing presence/absence of connection of the main unit 111 and the platforms 112 on the master side to the respective end points 105 included in the first relay device 101. By this, the end point (EP) for relay 107 of the second relay device 102 can acquire the state information representing presence/absence of connection to each of the end points 105 included in the first relay device 101.

The processing unit 121 of the root complex for relay 106 is configured to control data transfer between the first relay device 101 and the second relay device 102.

The second relay device 102 includes the switch 103 and the bus control processor 104. The second relay device 102 further includes eight end points 105 as connection units that are connectable to the respective platforms 113 on the slave side. The second relay device 102 further includes, as the relay connection unit that is connectable to another relay device, the end point (EP) for relay 107 enabling the second relay device 102 to connect to the first relay device 101. The configurations of the second relay device 102 are the same as the configurations of the first relay device 101 except the end point (EP) for relay 107. Thus, the configurations are denoted by the same reference numerals, and description thereof will not be repeated.

The bus control processor 104 of the second relay device 102 is configured to control communication with each of the platforms 113 on the slave side connected to the respective end points 105. The bus control processor 104 of the second relay device 102 also controls communication with the platforms 112 on the master side connected to the first relay device 101 via the relay end point 107 of the expansion bus (in the present embodiment, the PCIe bus).

The bus control processor 104 includes a specification unit 151 and an acquisition unit 152 as software configurations.

The specification unit 151 of the bus control processor 104 in the second relay device 102 is configured to specify a relation between the first relay device 101 and the second relay device 102, in other words, specify that the second relay device 102 is the master or the slave, by referring to the setting of the switch 103. The specification unit 151 according to the present embodiment specifies that the second relay device 102 is the slave.

The acquisition unit 152 of the bus control processor 104 in the second relay device 102 is configured to access the end point for relay 107 to acquire the state information representing presence/absence of connection to each of the end points 105 of the first relay device 101. The acquisition unit 152 then transmits the state information to each of the end points 105 of the second relay device 102. By this, each of the end points 105 of the second relay device 102 is able to recognize the connection state of the first relay device 101.

The first end point (EP) 105_1 to the eighth end point (EP) 105_8 of the second relay device 102 are the same as the first end point (EP) 105_1 to the eighth end point (EP) 105_8 of the first relay device 101, so that the description thereof is omitted.

The end point for relay 107 includes a processing unit 131 and a memory 132, and also includes a connection I/F for making connection with the root complex for relay 106.

The end point for relay 107 relays communication between the platforms 113 on the slave side and the platforms 112 on the master side via the root complex for relay 106.

The memory 132 of the end point for relay 107 is configured to store the state information representing presence/absence of connection to each of the end points 105 of the second relay device 102 via the bus control processor 104. By this, the root complex for relay 106 of the first relay device 101 is able to acquire the state information representing presence/absence of connection to each of the end points 105 of the second relay device 102.

The processing unit 131 of the end point for relay 107 is configured to control data transfer using the memory 132 to/from the first relay device 101 that is connected to the second relay device 102 via the connection I/F.

The main unit 111 includes two root complexes (RCs) 114, the processing unit 115, and the memory 116. When the processing unit 115 executes a computer program stored in the memory 116, the main unit 111 operates as a host personal computer (PC) functioning as a control unit and a graphical user interface (GUI) of the information processing system 1.

The platforms 112 on the master side and the platforms 113 on the slave side are each an information processing device that includes the root complex (RC) 114 of the expansion bus (in the present embodiment, the PCIe bus), the processing unit 115, and the memory 116, and performs various arithmetic operations. When the processing unit 115 executes a computer program stored in the memory 116, artificial intelligence (AI) inference processing, image processing, and the like are performed by the platforms 112 on the master side and the platforms 113 on the slave side.

The respective processing units 115 included in the main unit 111, the platforms 112 on the master side, and the platforms 113 on the slave side may be provided by different manufacturers (vendors), or may be provided by the same manufacturer.

The root complex 114 includes a connection I/F for making connection with the end point 105.

The memory 116 of each of the main unit 111 and the platforms 112 and 113 is used at the time of performing various kinds of processing. For example, the memory 116 is used to store information such as the address specifying information when it transmitted from the end point 105.

The processing unit 115 of each of the main unit 111 and the platforms 112 and 113 controls, by using the memory 116, data transfer to/from the end point 105 that is connected thereto via the root complex 114.

In the present embodiment, at the time of performing communication among the main unit 111 and the platforms 112 and 113, control similar to the control for communication over a virtual LAN is implemented by calling a virtual LAN driver and transmitting or receiving data. The following describes specific software configurations.

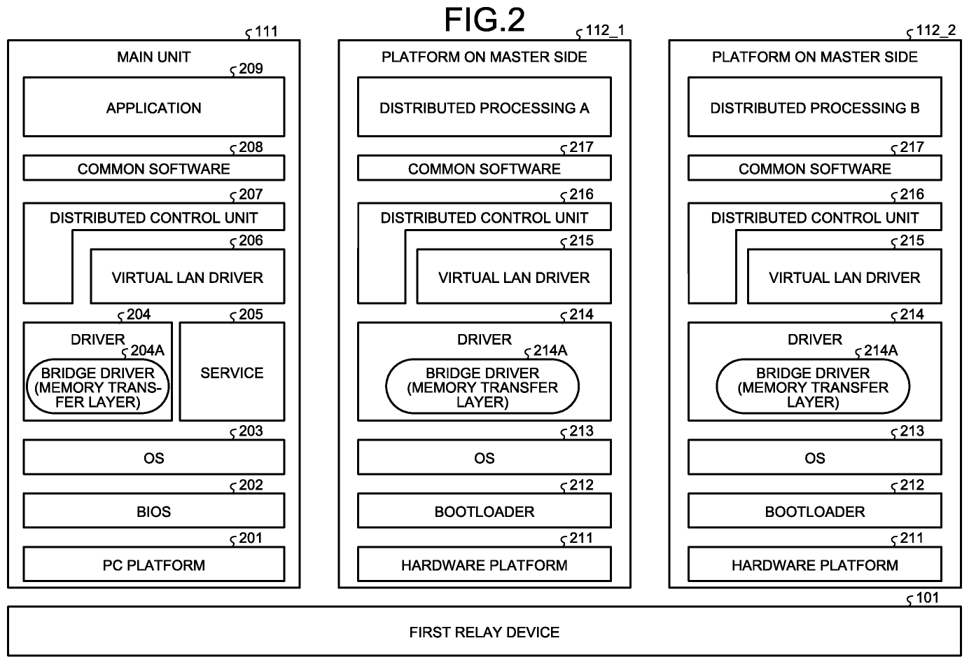

FIG. 2 is a block diagram exemplifying software configurations of the main unit and the platforms according to the present embodiment.

As illustrated in FIG. 2, the processing unit 115 of the main unit 111 executes an application 209 by implementing a BIOS 202, an OS 203, a driver 204, a service 205, a virtual LAN driver 206, a distributed control unit 207, and common software 208. A PC platform 201 of the main unit 111 is a hardware resource of the main unit 111.

The main unit 111 includes the BIOS 202 functions to read the OS 203 at the time of activation and perform basic input/output control for the main unit 111. The OS 203 is activated by the BIOS 202. The OS 203 may be Windows (registered trademark), for example, but any OS can be used.

The OS 203 functions to read various drivers 204 including a bridge driver 204A that is used for controlling the expansion bus (for example, the PCIe bus) and access the root complex 114 to communicate with another platform (for example, any of the platforms 112_1 to 112-6 on the master side and the platforms 113_1 to 113_8 on the slave side). The OS 203 also functions to read the service 205 for performing various kinds of control to perform various kinds of processing.

The virtual LAN driver 206 and the distributed control unit 207 are implemented in an upper layer of the driver 204 and the service 205. The application 209 implements communication with another platform (for example, any of the platforms 112_1 to 112-6 on the master side and the platforms 113_1 to 113_8 on the slave side) over a virtual LAN by accessing the virtual LAN driver 206 via the common software 208.

Similarly, the platforms 112_1 and 112_2 on the main side can perform distributed processing A and distributed processing B by implementing a Bootloader 212, an OS 213, a driver 214, a virtual LAN driver 215, a distributed control unit 216, and common software 217. A hardware platform 211 is a hardware resource of the platforms 112_1 and 112_2 on the main side.

In the platforms 112_1 and 112_2 on the main side, the Bootloader 212 is activated when a power supply is turned on, and the Bootloader 212 activates the OS 213.

The OS 213 reads various drivers 214 including a bridge driver 214A for controlling the expansion bus (for example, the PCIe bus), and accesses the root complex 114 to communicate with another platform (for example, any of the main unit 111, the platforms 112_3 to 112-6 on the master side, and the platforms 113_1 to 113_8 on the slave side).

The virtual LAN driver 215 and the distributed control unit 216 are implemented in an upper layer of the driver 214. By accessing the virtual LAN driver 215 via the common software 217, the distributed processing A and the distributed processing B implement communication with another platform (for example, any of the main unit 111, the platforms 112_3 to 112-6 on the master side, and the platforms 113_1 to 113_8 on the slave side) over the virtual LAN.

In order to implement communication over the virtual LAN as described above, it is required to assign a virtual Media Access Control (MAC) to each PCIe expansion bus. It may be considered that the virtual MAC address is assigned to each of the first end point 105_1 to the eighth end point 105_8 based on a CH number of the corresponding end point.

However, in a case of assigning the virtual MAC address based on the CH number alone, MAC addresses may conflict with each other between the first relay device 101 and the second relay device 102. Thus, in the present embodiment, the MAC address is assigned based on that the relay device is the master or the slave, in other words, based on the relation between the relay devices.

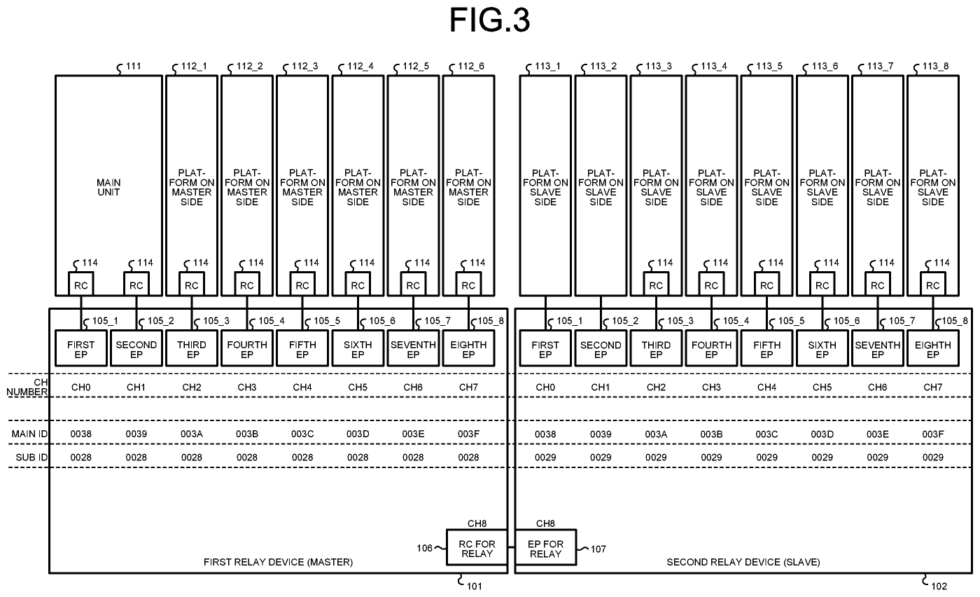

FIG. 3 is a diagram exemplifying a main ID and a sub ID assigned to each of the main unit 111 and the platforms 112 and 113 according to the present embodiment.

As illustrated in FIG. 3, CH0 to CH7 are respectively assigned to the first end point 105_1 to the eighth end point 105_8 of the first relay device 101. Thus, main IDs “0038” to “003F” corresponding to CH numbers are respectively and uniquely assigned to the main unit 111 and the platforms 112 on the main side connected to the first end point 105_1 to the eighth end point 105_8. Additionally, the relation (“master”) specified by the specification unit 151 is passed to the first end point 105_1 to the eighth end point 105_8 of the first relay device 101. By this, the processing unit 108 of each of the first end point 105_1 to the eighth end point 105_8 of the first relay device 101 specifies a sub ID “0028” corresponding to the relation (“master”) as the sub ID to be assigned to each of the main unit 111 and the platforms 112 on the main side that are connected thereto.

CH0 to CH7 are respectively assigned to the first end point 105_1 to the eighth end point 105_8 of the second relay device 102. Thus, the main IDs “0038” to “003F” corresponding to the CH numbers are respectively and uniquely assigned to the platforms 113 on the slave side connected to the first end point 105_1 to the eighth end point 105_8. Additionally, the relation (“slave”) specified by the specification unit 151 is passed to the first end point 105_1 to the eighth end point 105_8 of the second relay device 102. Due to this, the processing unit 108 of each of the first end point 105_1 to the eighth end point 105_8 of the second relay device 102 specifies a sub ID “0029” corresponding to the relation (“slave”) as the sub ID to be assigned to each of the platforms 113 on the slave side that are connected thereto.

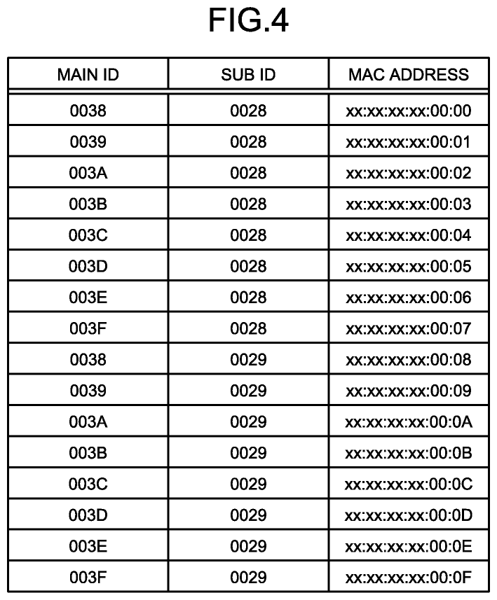

FIG. 4 is a diagram exemplifying a table structure of the address specifying information stored in the memory 109 according to the embodiment. As illustrated in FIG. 4, in the address specifying information, the main ID representing a position of the end point (connection unit) of the first relay device 101 or the second relay device 102, the sub ID representing the relation between the first relay device and the second relay device, and the virtual MAC address are linked with each other. The virtual MAC address here refers to an address that is virtually assigned to use within the virtual LAN driver for performing communication over the expansion bus (PCIe bus) in a lower layer while causing an upper layer to recognize a virtual LAN connection.

The processing unit 108 of the end point 105 transmits the main ID (the ID corresponding to a connecting position), the specified sub ID (the ID based on the relation), and the address specifying information to the main unit 111 or the platform 112 or 113 connected to this end point 105.

By referring to the address specifying information, the processing unit 115 of each of the main unit 111 and the platforms 112 and 113 assigns the virtual MAC address to implement transmission control performed by the virtual LAN driver of its own based on the specified sub ID and the main ID (ID corresponding to the position to which the main unit or the platform 112 or 113 is connected).

In a case of transmitting data to the platform within the same relay device, the processing unit 115 of each of the main unit 111 and the platforms 112 and 113 can specify the virtual MAC address assigned to a transmission destination based on the sub ID and the main ID corresponding to the position of the transmission destination (ID corresponding to the position to which the main unit or the platform 112 or 113 is connected) by referring to the address specifying information.

The processing unit 108 of the end point 105 transmits, as needed, the state information representing the connection state of the end point 105 of another relay device to the main unit 111 or the platform 112 or 113 connected thereto.

Therefore, the processing unit 115 of each of the main unit 111 and the platforms 112 and 113 can confirm whether the transmission destination is connected, based on the state information in a case in which the platforms 112 and 113 connected to another relay device is the transmission destination. When it is confirmed that the transmission destination is connected, the processing unit 115 can specify, by referring to the address specifying information, the virtual MAC address assigned to the transmission destination based on the main ID representing the connecting position of the transmission destination and the sub ID representing the relation of the connection destination.

For example, in a case in which any one of the main unit 111 and the platforms 112 on the master side connected to the first relay device 101 transmits some information to any one of the platforms 113 on the slave side connected to the second relay device 102, the processing unit 115 of each of the main unit 111 and the platforms 112 on the master side acquires the state information from the end point 105, and confirms whether any one of the platforms 113 on the slave side as the transmission destination is connected thereto based on the state information. Then, when it is confirmed that the transmission destination is connected thereto, any one of the main unit 111 and the platforms 112 on the master side specifies the virtual MAC address assigned to the transmission destination by referring to the address specifying information. The virtual LAN driver 206 or 215 operated by the processing unit 115 performs data transmission control based on the virtual MAC address (assuming that the main unit 111 or the platform 112 or 113 linked with the virtual MAC address is the transmission destination).

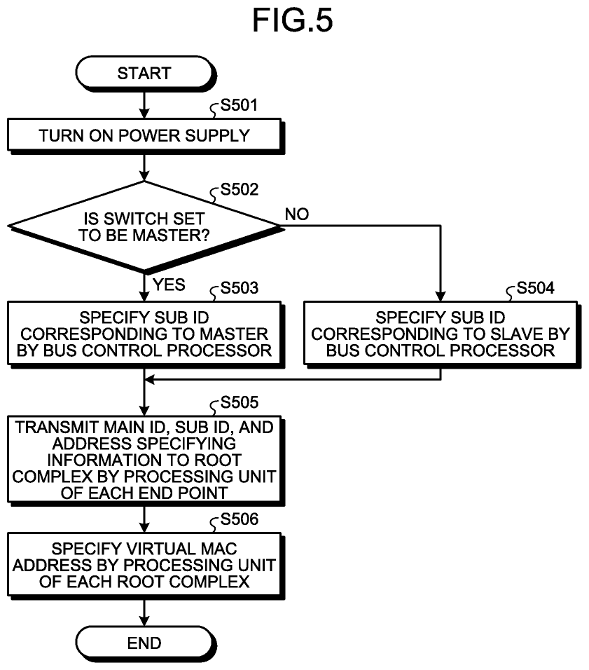

FIG. 5 is a flowchart illustrating processing for specifying the virtual MAC address by the platform 112 or 113 according to the present embodiment.

Firstly, the power supply of the information processing system 1 is turned on by being operated by a user (S501).

Next, the specification unit 141 or 151 of the bus control processor 104 of the first relay device 101 or the second relay device 102 determines whether the switch 103 is set to be the master (S502).

When it is determined that the switch 103 is set to be the master (Yes at S502), the specification unit 141 of the bus control processor 104 specifies the sub ID corresponding to the master and gives the specified sub ID to the end point 105 in the relay device 101 (S503).

On the other hand, when it is determined that the switch 103 is not set to be the master, in other words, the switch 103 is set to be the slave (No at S502), the specification unit 141 of the bus control processor 104 specifies the sub ID corresponding to the slave and gives the sub ID to the end point 105 in the relay device 102 (S504).

The processing unit 108 of the end point 105 in the relay device 101 or 102 transmits the main ID corresponding to the position of the end point, the given sub ID, and the address specifying information to the root complex 114 connected to this end point 105 (S505). The processing unit 115 of the main unit 111 or the platform 112 or 113 writes, into the memory 116, the main ID, the sub ID, and the address specifying information transmitted from the root complex 114.

The processing unit 115 of the main unit 111 or the platform 112 or 113 then specifies the virtual MAC address linked with the main ID and the sub ID by referring to the address specifying information (S506).

By the above processing, the virtual MAC address is assigned to each of the main unit 111 and the platforms 112 and 113.

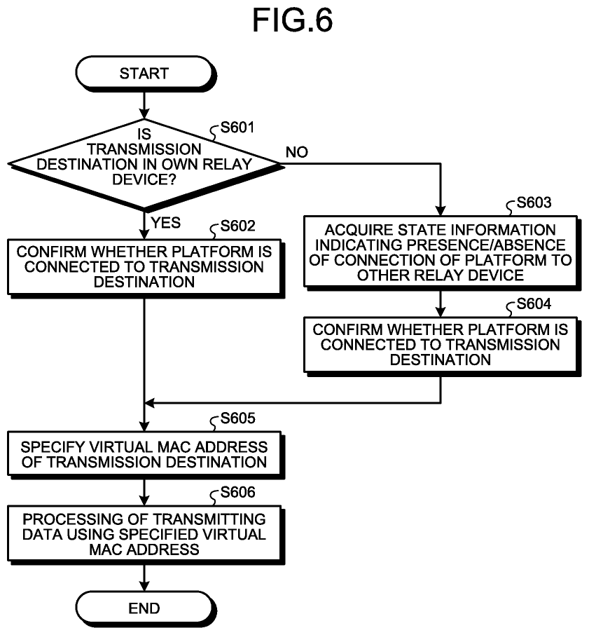

FIG. 6 is a flowchart illustrating processing for transmitting the information by the platform 112 or 113 according to the present embodiment.

Firstly, the processing unit 115 of the main unit 111 or the platform 112 or 113 determines whether the transmission destination is another platform in the own (or local) relay device (S601).

When it is determined that the transmission destination is another platform in the own relay device (Yes at S601), the processing unit 115 of the main unit 111 or the platform 112 or 113 confirms whether the platform 112 or 113 is connected to the end point 105 as the transmission destination via the end point 105 (S602).

On the other hand, if it is determined that the transmission destination is not another platform 112 or 113 in the own relay device (No at S601), the processing unit 115 of the main unit 111 or the platform 112 or 113 acquires the state information that has been acquired by the acquisition unit 152 of the bus control processor 104 (S603). The state information represents that the platform 112 or 113 is connected or not connected to another relay device.

The processing unit 115 of the platform 112 or 113 confirms, by referring to the state information, whether the platform 112 or 113 as the transmission destination of another relay device is connected (S604).

When it is confirmed that the platform is connected to the end point, the processing unit 115 of the main unit 111 or the platform 112 or 113 specifies the virtual MAC address corresponding to the platform 112 or 113 as the transmission destination by referring to the address specifying information (S605).

Then, the virtual LAN driver implemented in a processor (not illustrated) of the platform 112 or 113 performs data transmission control using the virtual MAC address specified as the transmission destination and the virtual MAC address for identifying the own platform 112 or 113 (S606). For example, the virtual LAN driver specifies which of channels on the master side or the slave side corresponds to the virtual MAC address, and performs data transmission control by using the specified channel as the transmission destination via the bridge driver 204A or 214A. In this way, in a hierarchical level upper than a software layer in a hierarchy of a communication protocol, a destination is designated with the MAC address at the time of transmitting data. In a driver layer lower than the software layer, transmission control is performed by using a channel on the master side or the slave side specified with the MAC address as the transmission destination.

While the present embodiment describes an example in which the address specifying information is stored in the memory 109 of the end point 105, a storage destination of the address specifying information is not limited thereto. For example, the address specifying information may be stored in advance in the memory 116 of the main unit 111 or the platform 112 or 113.

The present embodiment describes an example in which the processing unit 115 of the main unit 111 or the platform 112 or 113 specifies the virtual MAC address. The processing unit that specifies the virtual MAC address is not limited to the processing unit 115 of the main unit 111 or the platform 112 or 113. For example, the processing unit 108 of the end point 105 may specify the virtual MAC address to be transmitted to the root complex 114, or a processing unit (not illustrated) in the root complex 114 may specify the virtual MAC address. Alternatively, the bus control processor 104 may specify the virtual MAC address for each of the end points 105 to be transmitted to each of the root complexes 114.

The present embodiment describes an example of storing the table in which the main ID, the sub ID, and the virtual MAC address are linked with each other as the address specifying information. However, the address specifying information is not limited to the table in which the main ID, the sub ID, and the virtual MAC address are linked with each other. For example, the address specifying information may be information that enables assignment of a virtual MAC address based on the relation between the first relay device 101 and the second relay device 102, and the position of the connection unit of the first relay device 101 or the second relay device 102. The virtual MAC address may be generated by combining a predetermined number, a number denoting the main ID, and a number denoting the sub ID. In this case, the predetermined number is stored in the memory 109 of the end point 105 as the address specifying information. The present embodiment describes the example of specifying the virtual MAC address, but a target to be specified is not limited to the MAC address. The target may be an address that can specify the main unit 111 or the platform 112 or 113.

### Modification

The above embodiment describes a case in which the platform performs data transmission control for another platform. However, the use of the virtual MAC address is not limited to the case described in the above embodiment.

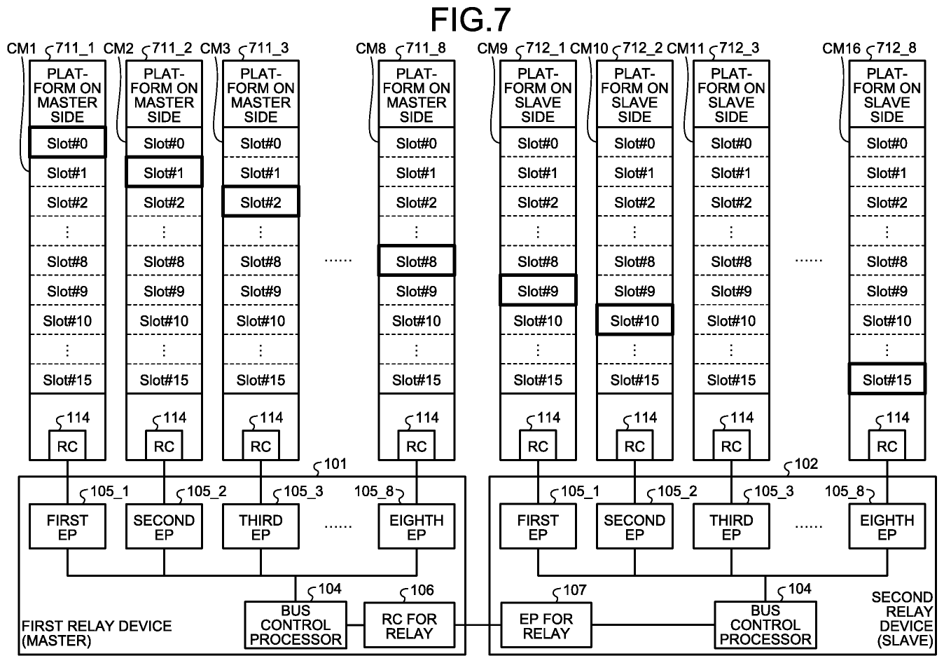

FIG. 7 is an explanatory diagram exemplifying a configuration of a common memory in each of the platforms according to a modification. As illustrated in FIG. 7, platforms 711_1 to 711_8 on the master side and platforms 712_1 to 712_8 on the slave side include common memories CM1 to CM16 having the same configuration.

The common memories CM1 to CM16 each include a first region Slot #0 to a sixteenth region Slot #15.

The first region Slot #0 in the common memory CM1 is a region where data to be received by the platform 711_1 on the master side from another platforms 711_1 to 711_8 on the master side and the platforms 712_1 to 712_8 on the slave side is written. The second region Slot #1 is a region where data (including an application) to be transmitted from the platform 711_1 on the master side to the platform 711_2 on the master side is written. Similarly, the third region Slot #2 to the eighth region Slot #7 are each a region where data to be transmitted from the platform 711_1 on the master side to the platforms 711_3 to 711_8 on the master side is written. The ninth region Slot #8 to the sixteenth region Slot #15 are each a region where data to be transmitted from the platform 711_1 on the master side to the platforms 712_1 to 712_8 on the slave side connected to the second relay device 102 is written. The second region Slot #1 in the common memory CM2 is a region where data to be received by the platform 711_2 on the master side from the other platforms 711_1 and 711_3 to 711_8 on the master side and the platforms 712_1 to 712_8 on the slave side is written. The first region Slot #0 and the third region Slot #2 to the eighth region Slot #7 are each a region where data to be transmitted from the platform 711_2 on the master side to the other platforms 711_1 and 711_3 to 711_8 on the master side is written. The ninth region Slot #8 to the sixteenth region Slot #15 are each a region where data to be transmitted from the platform 711_2 on the master side to the platforms 712_1 to 712_8 on the slave side connected to the second relay device 102 is written.

The same configuration as above applies to the other common memories CM3 to CM16, so that the description thereof is omitted. One of the regions of the common memory is a region where data to be received from another platform is written, and the other regions of the shared memory are regions where data to be transmitted to the other platforms is written.

In the configuration described above, when any of the platforms writes data to be transmitted to another platform into a predetermined address of a corresponding region, the address of the region into which the data is written is given to the bus control processor 104 via a device driver.

The bus control processor 104 discriminates the common memory of the platform as a transfer destination of the written data based on the given address of the region. Then, the bus control processor 104 transfers the data and writes the data into the address of the corresponding region (that is, the same address as the address of the region into which the data is written by the platform as a transmission source). In this control, the virtual MAC address is used as the transmission source and the transmission destination of the platform. A method of transmitting the data that is actually performed is the same as that in the embodiment, and the description thereof is omitted.

In the present modification, a result of an arithmetic processing performed by each platform can be read out from the common memory, so that transmission and reception of the data are facilitated.

In the embodiment and the modification, while the first relay device 101 to which the main unit 111 and the platforms 112 on the master side includes the root complex (RC) for relay 106, the second relay device 102 includes the end point (EP) for relay 107. However, the embodiment and the modification are not limited to such a configuration. For example, it is possible to employ a configuration in which the end point (EP) for relay 107 is provided to the first relay device 101 to which the main unit 111 and the platforms 112 on the master side while the root complex (RC) for relay 106 is provided to the second relay device 102.

In addition, the correspondence between the first/second relay devices defined in Claims and those in the embodiment is not fixed but is flexible. For example, it is possible to interpret that the first relay device 101 in the embodiment corresponds to the second relay device in Claims while the second relay device 102 in the embodiment corresponds to the first relay device in Claims.

With the information processing system according to the embodiment and the modification described above, when communication is performed between the information processing devices that are connected to each other via the relay devices, the address conflict between the virtual MAC addresses can be prevented by assigning the virtual MAC addresses based on the relation between the relay devices. Thus, appropriate communication processing can be implemented between the information processing devices connected via the relay devices.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system comprising:
a first relay device provided with a plurality of end points and a root complex for relay; and
a second relay device provided with a plurality of end points and an end point for relay, wherein
the plurality of end points of the first relay device individually connects to any of a plurality of first information processing devices over an expansion bus,
the root complex for relay:
relays communication between the first information processing devices via the corresponding end points of the first relay device;
connects to the second relay device over an expansion bus; and
functions as a root complex,
the plurality of end points of the second relay device individually connects to any of a plurality of second information processing devices over an expansion bus,
the end point for relay:
relays communication between the second information processing devices via the corresponding end points of the second relay device;
connects to the first relay device over an expansion bus; and
functions as an end point,
the second relay device relays communication between the first information processing devices and the second information processing devices via the end point for relay,
the first relay device or the second relay device further comprises:
a memory that stores address specifying information used for assigning addresses to the first information processing devices or the second information processing devices connected to the respective positions of the corresponding end points, the addresses to be assigned being based on a relation between the first relay device and the second relay device and based on positions of the end points of the first relay device or the second relay device;
one or more hardware processors that:
specify the relation between the first relay device and the second relay device; and
assign the addresses to the first information processing devices or the second information processing devices connected to the end points of the first relay device or the second relay device based on the specified relation, the positions of the connected end points, and the address specifying information.

2. The information processing system according to claim 1, wherein the one or more hardware processors assign, as the addresses, virtual MAC addresses to the first information processing devices or the second information processing devices connected to the end points of the first relay device or the second relay device.

3. The information processing system according to claim 1, wherein the one or more hardware processors of the first relay device:
acquire state information representing presence/absence of connection of the second information processing devices to the respective end points of the second relay device; and
assign the addresses to the second information processing devices connected to the second relay device based on the state information, the specified relation, the positions of the end points to which the second information processing devices are connected, and the address specifying information.

4. The information processing system according to claim 3, wherein
the first information processing devices and the second information processing devices are provided in the information processing system, and
the information processing system, when any one of the first information processing devices transmits information to any one of the second information processing devices:
acquires the state information;
confirms, based on the acquired state information, whether any one of the second information processing devices is connected; and
transmits the information depending on a result of the confirmation.

5. A relay device comprising:
a plurality of end points that individually connects to any of a plurality of information processing devices over an expansion bus;
a root complex for relay or an end point for relay that:
connects to another relay device over an expansion bus, and
functions as a root complex or an end point; and
a memory that stores address specifying information used for assigning addresses to the information processing devices connected to the respective positions of the end points, the addresses to be assigned being based on a relation with another relay device and positions of the end points.

6. The relay device according to claim 5, further comprising one or more hardware processors that:
specifies a relation between the relay device and another relay device; and
transmits, to the information processing devices connected to the end points, the specified relation, the positions of the connected end points, and the address specifying information.
